(19) United States
(12) Patent Application Publication
(10) Pub. No.: US 2015/0024918 A1
(43) Pub. Date: Jan. 22, 2015

(54) STATION OF APPLICATION OF SEGMENTS OF OPENING/CLOSING STRIP ON PLASTIC WEB FILMS SUITABLE TO FORM BAGS

(71) Applicant: SALES S.P.A., Rivoli (TO) (IT)

(72) Inventor: Emilio Tessera Chiesa, Rivoli (TO) (IT)

(21) Appl. No.: 14/381,204

(22) PCT Filed: Feb. 25, 2013
(86) PCT No.: PCT/IB2013/000280

§ 371 Date: Aug. 26, 2014

(30) Foreign Application Priority Data
Feb. 27, 2012 (IT) MI2012A000286

(51) Int. Cl. B31B 1/14; B31B 1/64; B31B 1/90; B31B 1/18

(52) U.S. Cl. CPC B31B 1/14; B31B 1/18; B31B 1/64; B31B 1/90
USPC 493/189; 493/214; 493/227; 493/256

(57) ABSTRACT

A station (S) of application of segments of opening/closing strip on plastic web films suitable to form bags, comprising punching means (U14, U22) of predefined areas of the plastic film for the access to areas of the segments through the film, and welding means (U15, U23) of the strip segments at intervals on the plastic film, wherein the punching means (U14, U22) and the welding means (U15, U23) are positioned along the flow path of the film to act in sequence on the same area in order to, respectively, punch the film and weld the segments in the predetermined points of the plastic film. In particular, the station (S) comprises two operating units (U1, U11; U2, U21), suitable to cooperate from opposite sides with the plastic film, each of which provided with the punching means (U14, U22) and the welding means (U15, U23), angularly staggered with respect to the punching means (U14, U22), and operatively connected with translation means (U31) that move at least one of the operating units (U1, U11; U2, U21) to bring them closer and separated, allowing the execution of the punching of the plastic film by the punching means (U14, U22) and the welding of the strip segment in the punched area of the plastic film, and with motorization means (U12, U21) that rotate the operating units (U1, U11; U2, U21) around longitudinal axes for selectively and alternately arranging the welding means (U15, U23) and the punching means (U14, U22) facing to the plastic film.

The present invention refers to a station of application of segments of opening/closing strip on plastic web films suitable to form bags.

With reference to the enclosed FIG. 8, a bag of plastic film that can be made through the aforesaid station is therein shown.

These bags are equipped with a strip element (or segment) welded to a wall of the bag (generally on the inner face) and able to give the characteristic of being easily openable and reclosable to the bag itself: on the bag, in fact, strip elements are arranged having a tear thread that, when pulled, tears up the bag along an opening line; to enable the reclosure thereof, the bag (or the strip element fastened thereto) is provided with an adhesive band that suitably uncovered allows the reclosure thereof.

These strip elements require that punchings for accessing the element and for starting the tear are provided in appropriate positions on the wall of the bag.

A station of the specified type is known for example from EP 1 584 562 A1 and comprises, essentially, punching means of predefined areas of the plastic film for the access to areas of the strip segments through the film and welding means of the strip segments at intervals on the plastic film, wherein the punching means and the welding means are positioned in the station along the flow path of the film to act in sequence on the same zone for punching the film and for welding the segments in the predetermined points of the film, keeping the film stationary between the punching operation of the film itself and the corresponding welding operation of a strip segment on the film.

In particular, in the station according to the aforesaid document EP 1 584 562 A1, the welding means comprise two welding opposed surfaces, mutually movable towards each other with interposition of the plastic film and of the strip segment to be welded to the film, and the punching means comprise on one face of the film at least one punch movable towards the surface of the film and on the opposite face of the film contrast means, which are movable between an operative position, in which are interposed between one of the welding surfaces and the corresponding face of the film to make abutment with the punch, and a non-operative position outside the interposition, to permit the approach of the welding surfaces and the welding of the strip segment on the film that is interposed between them.

Although functioning, the station of application described in EP 1 584 562 A1 shows some recognized drawbacks.

A first drawback of the station of application according to EP 1 584 562 A1 resides in the fact that the punch is provided movable towards the surface of the film through (or, anyway, near to) one of the welding surfaces.

The consequent heating of the punch causes therefore a rapid wear of the relevant contrast means and of the punch itself.

Furthermore, the fact that the contrast means of the punch, when they assume the operative position, are interposed between one of the welding surfaces and the corresponding face of the film, while, when they assume the non-operative position, are arranged outside the interposition, complicates the structure and the operation of the station itself, limiting the operational performance thereof.

Furthermore, in the aforesaid station, the means causing the operative motion of the welding means and of the punching means comprise actuators, for example pneumatic, that for their own structure do not allow to reach the accuracy and the operational rhythm necessary for a correct and efficient operation of the station itself.

The present invention, starting from the knowledge of the aforesaid drawbacks according to the prior art, aims to overcome them.

In particular, an object of the invention is to provide a station of application of segments of opening/closing strip on plastic web films suitable to form bags allowing to substantially limit the wear of the punch and of the relevant contrast means.

Another object of the present invention is to provide a station of the specified type allowing to avoid, during the processing, the interposition of the contrast means of the punch between one of the welding surfaces and the corresponding face of the film, simplifying the structure of the station itself and increasing the operational performance thereof.

A last but not least object of the present invention is to provide a station of the indicated type allowing to avoid the use of actuators to cause the operative motion of the welding means and of the punching means, improving the accuracy and the speed of the operational rhythm of the station for a more correct and efficient operation.

In view of these objects, the present invention provides a station of application of segments of opening/closing strip on plastic web films suitable to form bags, having the features of the attached first claim, to which reference is made for presentation brevity.

Further advantageous technical features of detail of the station of application according to the invention are described in the relevant dependent claims.

The aforesaid claims, as hereinafter defined, are considered to form integral part of the present description.

The present invention, together with its objects and advantages, will become more evident from the following detailed description, concerning a preferred embodiment of the station of application herein exclusively claimed, given by way of illustrative, but not limiting, example, with reference to the enclosed drawings tables, also given only by way of example, in which:

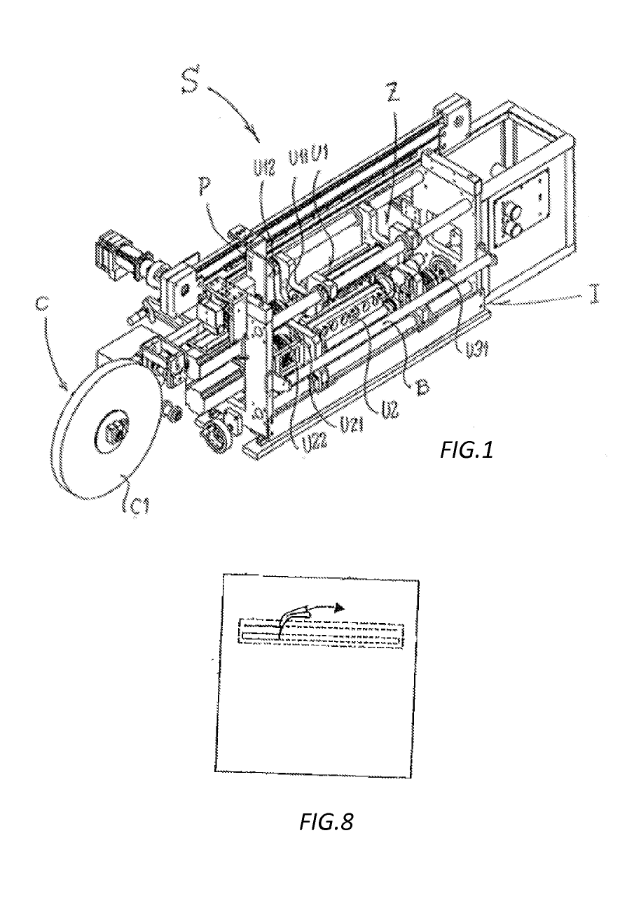

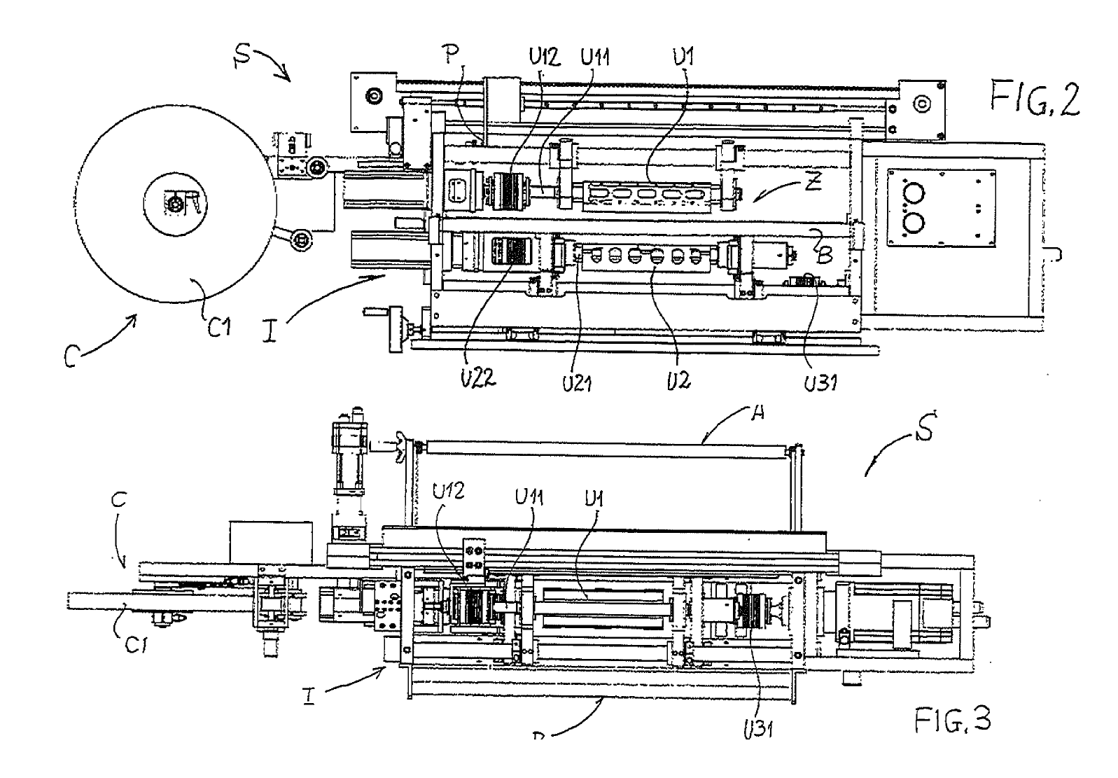

FIGS. 1, 2 and 3 are overall views of an illustrative embodiment of the station of application of segments of opening/closing strip on plastic web films intended to form bags according to the invention, in top perspective (FIG. 1), in front elevation (FIG. 2) and in top plan (FIG. 3) respectively;

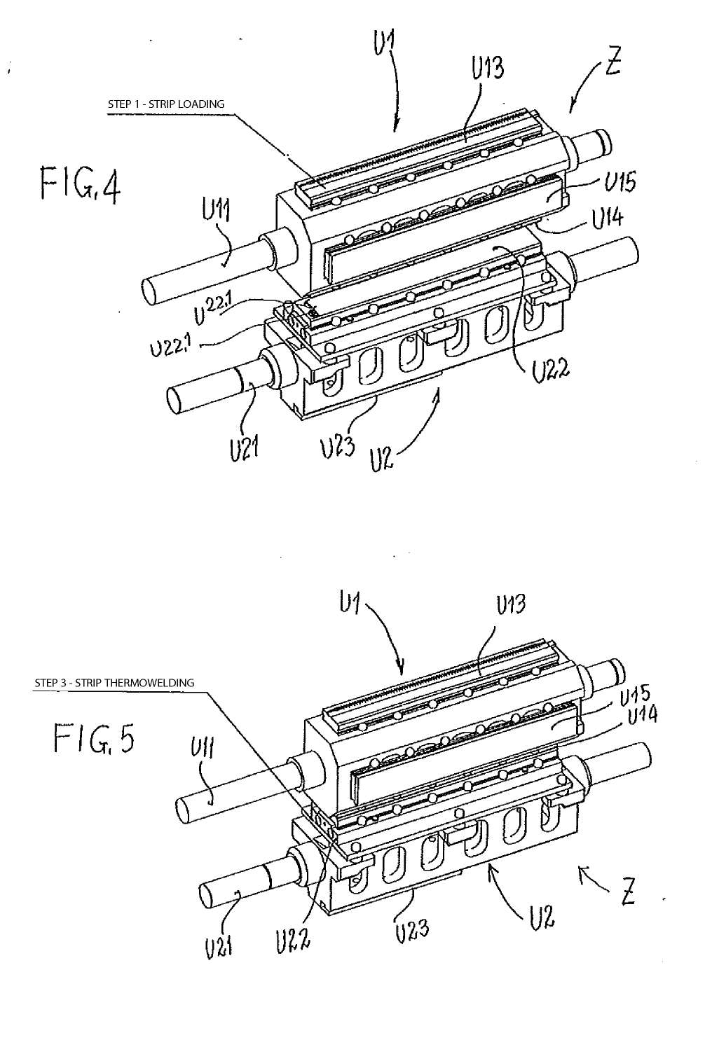

FIGS. 4 to 7 are schematic perspective views of two operating units including the respective shafts, which are provided to cooperate with each other in the station according to steps 1 to 3, so as to apply segments of opening/closing strip on plastic web films intended to form bags; said two units, for explanatory clarity, are shown removed from the station itself and are represented in different mutual operational arrangements, corresponding to respective steps of a working cycle.

Firstly with reference to FIGS. 1 to 3 of the drawing, with S is denoted as a whole a station of application of segments of opening/closing strip on plastic web films intended to form bags, according to an embodiment of the invention.

Said station S comprises a framework I having a substantially portal structure, through which a plastic film in continuous strip form (not shown), intended to form a bag for the packaging of products, is fed and made to pass. Said plastic film is unwound, upstream, from a coil (also not shown), which is rotating supported through a rotating reel A (FIG. 3) with horizontal axis, arranged at the rear of the framework I, while downstream said film rests, upon exiting the station S, on a supporting bar B with an axis horizontal and parallel to that of the reel A. Said bar B is cantilevered from the framework I and it is arranged in front of the same.

With C feeding means of a suitable continuous strip (not shown) in a direction transverse to the feeding direction of said plastic film are denoted. Said feeding means C are arranged laterally to the framework I and comprise a coil C1 rotating supported with respect to a horizontal axis, oriented in a direction substantially orthogonal to that of the axis of the reel A.

From said coil C1 (for example with a sliding gear actuating a tensioning brake) the continuous strip is unwound toward a punching and welding area Z (FIG. 2) inside the framework I, where the strip itself is preliminarily cut into strip segments of predetermined length, according to a well-established technique in the reference field—known, for example, from document EP 1 584 562 A1—and, therefore, here not further illustrated and described. In the station S according to the invention various kinds of strip segments can be treated, among which a kind of segment comprising an adhesive band and a tear thread, which is applied on the plastic film with one end accurately positioned with respect to two “half-moon” punchings made on the film itself through punching means better described hereinafter.

In said inner area Z of the framework I with two operating units U1, U2 are provided, upper and lower respectively, i.e. arranged from opposite sides (above and below) with respect to said plastic film, angularly rotating about respective axes substantially parallel to that of the reel A and mutually opposed.

In particular and with reference also to FIGS. 4 to 7, in said area Z of the framework I there are provided:

a shaft U11, placed in an upper position with respect to said plastic film, stationary supported with respect to the framework I and selectively rotated in opposite directions (in an angular range of ±180° by a respective brushless electric motor with reducer U12, fixed with respect to the framework itself;

a shaft U21, placed in a lower position with respect to said plastic film, vertically mobile supported in said framework I, with alternate approaching and removal motion with respect to said upper shaft U11, by support means sliding in corresponding vertical rectilinear guides fastened to said framework. Said shaft U21 is rotated, for example in opposite directions (in an angular range of ±180°, by a respective brushless electric motor with reducer U22, fixed with respect to said support means. The axes of the aforesaid two shafts U11, U21 are parallel to each other and to that of the reel A and are substantially contained in the same vertical plane;

said upper operating unit U1, which is integral in rotation with respect to said upper shaft U11 and has a body of a substantially rectum parallelepiped general shape, ideally inscribed in a cylinder whose axis coincides with that of said shaft U11 and which fixedly supports, respectively:

a1) on a first side face, tray or storing means U13 for loading and temporarily retaining a strip segment cut to size, wherein said strip segment is oriented in the direction of the axis of the shaft U11, which substantially coincides with the direction of application of the segment itself on the underlying plastic film;

b1) on a second side face opposite (with respect to the axis of U11) to said first face, plate means to contrast the punching U14;

c1) on a side face intermediate between said first and second faces, the first plate means with thermowelding surface U15, and

said lower operating unit U2, which is integral in rotation with respect to said lower shaft U21 and has a body of a substantially rectum parallelepiped general shape, ideally inscribed in a cylinder whose axis coincides with that of said shaft U21 and which fixedly supports, respectively:

a2) on a first side face, punching means U22 with two substantially “half-moon” punches U22.1;

b2) on a second side face opposite (with respect to the axis of U21) to said first face, second plate means with a thermowelding surface U23, and

gripper means P (FIG. 2) for sequentially withdrawing each of the strip segments cut to size upstream said upper unit U1 and for storing the same in said tray means U13 of the unit U1. Said tray means U13 comprise suction means, pneumatically connected with vacuum pump means (known per se to those skilled in the art and, for presentation convenience, not shown), and a coating or surface with suction holes on their upper face (on which the strip segment being processed is laid) of a heat resistant material, such as teflon®.

It will be noted that the lower shaft U21 with the relevant lower unit U2 is vertically mobile supported in said framework I, with alternate approaching and removal motion with respect to the upper shaft U11, through an underlying camshaft, stationary and having axis parallel and contained in the same vertical plane with respect to that of the lower shaft U21.

Said camshaft is rotated by a respective brushless electric motor with reducer U31, fixed with respect to the framework I.

Said camshaft supports two eccentric, fixed and cooperating with corresponding sliding blocks with cam-followers provided in said support means of said lower shaft U21; said sliding blocks are guided in corresponding rectilinear vertical guides fixed in the framework I.

In the enclosed FIG. 8 the strip segment applied on the plastic film is illustrated, in correspondence with punched flaps of the film, for tear opening and temporary reclosure of a bag formed using the film itself.

In the station S according to the present invention, as will become more evident hereinafter, plastic film and strip segment are joined in line, according to a configuration always resulting from the arrangement of FIG. 8 hereto enclosed, i.e. in correspondence with punched flaps of the plastic film, for tear opening and subsequent temporary reclosure of a bag formed using the film itself.

### Description of a Running Cycle of the Station S According to the Invention (FIGS. 4 to 7 in this order).

The upper unit U1 and the lower unit U2 of the station S are initially spaced from each other and a plastic film in continuous strip form (not shown and, as mentioned, intended to form bags) is interposed between them, which film is suitably fed through the station S while remaining stationary during the whole running cycle described hereinafter.

Step 1 (FIG. 4)

The tray means U13 of the upper unit U1 are arranged in a horizontal plane with their suction surface facing upward. The gripper means P lay on said tray U13 a strip segment (not shown), which is therein retained by suction.

Furthermore, the plate means to contrast the punching U14 of the upper unit U1 are arranged immediately above the plastic film.

In this step, the lower unit U2 of the station S has the punching means U22 facing the overlying plastic film.

Step 2 (FIG. 6)

The upper unit U1 with shaft U11 is maintained stationary, while the lower unit U2 with shaft U21 is raised, by the cam means driven by the motor U31, until the two punches U22.1 of the punching means U22 cut the plastic film and are in abutment with the contrast plate means U14 of the upper unit U1. Two “half-moon” punches are thus made on the film itself.

Subsequently (this operation is not shown in the drawing), the lower unit U2 with shaft U21 is lowered, by the cam means driven by the motor U31, carrying out an inverse stroke to the raising one.

The upper unit U1 is solidly rotated with the shaft U11 around the axis thereof at an angle (here taken as positive) of +180° (also this operation is not shown in the drawing), so to bring the suction surface of the tray U13 immediately above the plastic film. Upon completion, the suction action of the vacuum pump means is stopped and the strip segment is laid by gravity on the plastic film, exactly in line in the area of the two “half-moon” punchings.

Step 3 (FIG. 5)

The upper unit U1 is solidly rotated with the shaft U11 around the axis thereof at a negative angle of −90° (i.e., the aforesaid shaft U11 carries out a partial rotation, preferably inverse to the previous one), in such a way to place the first plate means with thermowelding surface U15 immediately overlying the plastic film in the area thereof having the two “half-moon” punchings.

At the same time, the lower unit U2 is solidly rotated by 180° with the shaft U21 around the axis thereof, so as to place the second plate means with thermowelding surface U23 immediately underlying said area with punchings of the plastic film and the punching means U22, opposite to the second plate means with thermowelding surface U23 themselves, facing downwards.

The lower unit U2 with shaft U21 is then raised, by the cam means driven by said motor U31, until the second plate means with thermowelding surface U23 press, for the necessary time, the aforesaid area of the plastic film, on which the strip segment is arranged in line, against the first plate means with thermowelding surface U15 of the upper unit U1.

The thermowelding is thus made on the plastic film of said strip segment positioned, in said area of the plastic film, in line with said two “half-moon” incisions.

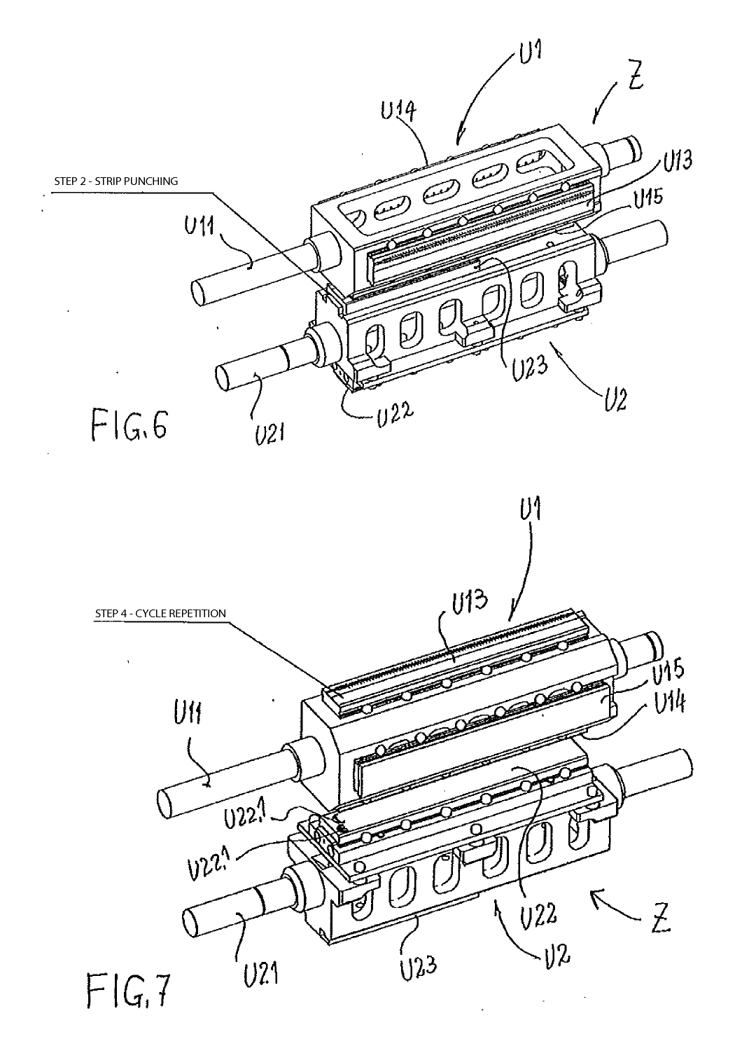

Step 4 (FIG. 7)

Finally, the lower unit U2 is lowered again, by the cam means driven by the motor U31, carrying out an inverse stroke to the raising one and it is subsequently solidly rotated by 180° with the shaft U21 around the axis thereof, so as to rearrange the punching means U22 facing the overlying plastic film.

In its turn, the upper unit U1 is further solidly rotated with the shaft U11 around the axis thereof at a negative angle of −90°, in order to rearrange the tray means U13 in a horizontal plane with their suction surface facing upward.

The two units U1 and U2 are thus brought back to the initial arrangement and, after the plastic film has been advanced of the desired length and the suction of the vacuum pump means through the suction surface of the tray U13 is restored, the running cycle of the station S can be repeated.

The above-described running cycle of the station S is carried out in an automated way under the control of a software program performed by programmable logic control (PLC) means.

### Advantages of the Station According to the Invention

As results from the foregoing, the invention provides a station of application of segments of opening/closing strip on plastic web films intended to form bags, which allows to achieve the following main advantages:

since the punching means are arranged far from the welding means, the rapid wear of the former and of the relevant contrast means due to heat induced by the latter is avoided;

the punching contrast means do not interpose between one of the welding surfaces and the corresponding face of the film; therefore, the structure and the operation of the station are simplified and the operational performance is increased;

the means causing the operative motion of the welding means and of the punching means do not comprise any actuators, in particular pneumatic ones, but cam means and cam-followers driven by electric motorization means. This fact allows to operate, in the station according to the invention, with high accuracy and operational rhythm, achieving a correct and efficient operation of the station itself.

Basing on what above illustrated, it is therefore understood that the station of application of segments of opening/closing strip on plastic web films suitable to form bags, which is the subject of the present invention, achieves the objects and realizes the advantages previously mentioned.

A further advantage of the present invention concerned the improved accessibility to all the component parts of the machine, thus simplifying any interventions of maintenance and/or shape or die replacement and adjustments (e.g. set-up) in general.

Finally, it is clear that several other variants may be made to the station of application in question, without departing for this from the novelty principles inherent in the inventive idea, as well as it is clear that, in practical embodiments of the invention, the materials, the shapes and sizes of the illustrated details may be whichever, depending on the needs, and may be replaced with other technically equivalent.

Where the construction features and the techniques mentioned in the subsequent claims are followed by reference signs or numbers, those reference signs have been introduced with the sole purpose of increasing the intelligibility of the claims themselves and, consequently, they have no limiting effect for the interpretation of each element identified, by way of example only, by such reference signs.

1. Station of application of segments of opening/closing strip on plastic web films suitable to form bags, comprising:
punching means of predefined areas of said plastic film for the access to areas of said segments through said film;
welding means of said strip segments at intervals on said plastic film, wherein said punching means and said welding means are positioned along the flow path of said film in such a way to act in sequence on the same area in order to, respectively, punch said film and weld said segments in the predetermined points of said plastic film,
two operating units, suitable to cooperate from opposite sides with said plastic film, each of which provided with said punching means and said welding means, angularly staggered with respect to said punching means, and operatively connected with:
translation means suitable to move at least one of said operating units in such a way as to bring them closer and separated, allowing the execution of said punching of said plastic film by said punching means and said welding of said strip segment in said punched area of said plastic film;
motorization means suitable to rotate said operating units around longitudinal axes in such a way as to selectively and alternately arrange said welding means and said punching means facing to said plastic film.

2. Station according to claim 1 wherein said longitudinal axes of said operating units are parallel each other.

3. Station according to claim 1 wherein said punching means of one of said operating units are complementary to the punching means of the other operating unit.

4. Station (S) according to claim 1, wherein at least one of said operating units is equipped with storing means angularly staggered with respect to the punching means and to the welding means of the unit itself, for temporarily retaining and operatively positioning a strip segment in a predetermined area of said plastic film.

5. Station according to claim 4 wherein in at least one position of relative angular rotation of said operating units, said punching means are operatively opposed from opposite sides of said plastic film and produce at least one incision in an area of said film, as a result of the mutual approach of said two units by said translation means, and, after the mutual removal of said units by said translation means, in another position of relative angular rotation of said operating units, a strip segment is positioned by said storing means in said area of said plastic film in line with said at least one incision and, in a further position of relative angular rotation of said operating units, said welding means are operatively opposed from opposite sides of the plastic film, as a result of the mutual approach of said units by said translation means, and perform the welding of said strip segment in said area of said plastic film in line with said at least one incision, after which said operating units are mutually spaced apart by said translation means.

6. Station according to claim 1 wherein a first of said operating units comprises at least:
storing means for loading and holding a strip segment cut to size, wherein said segment is oriented in the direction of application of said segment on said plastic film;
punching contrast means, respectively of the punching means with at least one punch;
first welding means.

7. Station (S) according to claim 1 wherein said first operating unit is arranged above said plastic film and wherein said storing means present, at the beginning of the running cycle, a sucking surface facing upwardly and pneumatically connected with pneumatic vacuum-generating means for temporarily retaining a strip segment in said storing means, while said strip segment is laid on said plastic film when said sucking surface of said storing means is directed towards said plastic film and said pneumatic connection is interrupted.

8. Station according to claim 1, wherein a second of said operating units comprises at least:
punching means with at least one punch, respectively of the punching contrast means;
second welding means.

9. Station according to claim 1, wherein it comprises a framework in which are provided:
an upper shaft, placed above said plastic film, stationary supported with respect to the framework and selectively rotated in opposite directions by respective electric motorization means with reducer, fixed with respect to said framework;
a lower shaft, placed below said plastic film, vertically mobile supported in said framework, with alternate approaching and removal motion with respect to said upper shaft, by said translation means and rotated by respective electric motorization means with reducer, movable with said shaft;
the axes of said shafts being parallel each other and substantially contained in the same vertical plane;
said upper operating unit being integral in rotation with said upper shaft, and
said lower operating unit being integral in rotation with said lower shaft.

10. Station according to claim 9,
wherein said first operating unit is arranged above said plastic film and wherein said storing means present, at the beginning of the running cycle, a sucking surface facing upwardly and pneumatically connected with pneumatic vacuum-generating means for temporarily retaining a strip segment in said storing means, while said strip segment is laid on said plastic film when said sucking surface of said storing means is directed towards said plastic film and said pneumatic connection is interrupted
and wherein it comprises gripper means of sequentially withdrawal of strip segments, cut to size upstream said upper unit, and of sequentially storage of each of said segments in said storing means of the upper unit, when said storing means have their sucking surface facing upwardly.

11. Station according to claim 9,
wherein a first of said operating units comprises at least:
storing means for loading and holding a strip segment cut to size, wherein said segment is oriented in the direction of application of said segment on said plastic film;
punching contrast means, respectively of the punching means with at least one punch;
first welding means
wherein said first operating unit is arranged above said plastic film
wherein said storing means present, at the beginning of the running cycle, a sucking surface facing upwardly and pneumatically connected with pneumatic vacuum-generating means for temporarily retaining a strip segment in said storing means, while said strip segment is laid on said plastic film when said sucking surface of said storing means is directed towards said plastic film and said pneumatic connection is interrupted and
wherein characterized in that said operating units present each a body of a substantially rectum parallelepiped general shape, ideally inscribed in a cylinder whose axis coincides with that one of the respective shaft, and equipped with respective punching means and welding means and, with reference to at least the upper unit, with storing means for temporarily containing one of said strip segments.

12. Station according to claim 9, wherein said translation means of at least one of said operating units include:
a camshaft stationary with respect to said framework, placed below said lower shaft, having axis parallel and contained in the same vertical plane with respect to that one of said lower shaft and rotated by respective electric motorization means with reducer, fixed in respect of said framework;
supporting means of said lower shaft including sliding blocks guided in corresponding rectilinear vertical guides fixed with respect to said framework and provided with cam-follower means cooperating with corresponding eccentrics integral with said camshaft.

13. Station according to claim 2 wherein said punching means of one of said operating units are complementary to the punching means of the other operating unit.

14. Station according to claim 2, wherein at least one of said operating units is equipped with storing means angularly staggered with respect to the punching means and to the welding means of the unit itself, for temporarily retaining and operatively positioning a strip segment in a predetermined area of said plastic film,
wherein in at least one position of relative angular rotation of said operating units, said punching means are operatively opposed from opposite sides of said plastic film and produce at least one incision in an area of said film, as a result of the mutual approach of said two units by said translation means, and, after the mutual removal of said units by said translation means, in another position of relative angular rotation of said operating units, a strip segment is positioned by said storing means in said area of said plastic film in line with said at least one incision and, in a further position of relative angular rotation of said operating units, said welding means are operatively opposed from opposite sides of the plastic film, as a result of the mutual approach of said units by said translation means , and perform the welding of said strip segment in said area of said plastic film in line with said at least one incision, after which said operating units are mutually spaced apart by said translation means.

15. Station according to claim 3, wherein at least one of said operating units is equipped with storing means angularly staggered with respect to the punching means and to the welding means of the unit itself, for temporarily retaining and operatively positioning a strip segment in a predetermined area of said plastic film,
wherein in at least one position of relative angular rotation of said operating units, said punching means are operatively opposed from opposite sides of said plastic film and produce at least one incision in an area of said film, as a result of the mutual approach of said two units by said translation means, and, after the mutual removal of said units by said translation means, in another position of relative angular rotation of said operating units, a strip segment is positioned by said storing means in said area of said plastic film in line with said at least one incision and, in a further position of relative angular rotation of said operating units, said welding means are operatively opposed from opposite sides of the plastic film, as a result of the mutual approach of said units by said translation means , and perform the welding of said strip segment in said area of said plastic film in line with said at least one incision, after which said operating units are mutually spaced apart by said translation means.

16. Station according to claim 13, wherein a first of said operating units comprises at least:
storing means for loading and holding a strip segment cut to size, wherein said segment is oriented in the direction of application of said segment on said plastic film;
punching contrast means, respectively of the punching means with at least one punch;
first welding means.

17. Station according to claim 14, wherein a first of said operating units comprises at least:
storing means for loading and holding a strip segment cut to size, wherein said segment is oriented in the direction of application of said segment on said plastic film;
punching contrast means, respectively of the punching means with at least one punch;
first welding means.

18. Station according to claim 9, wherein at least one of said operating units is equipped with storing means angularly staggered with respect to the punching means and to the welding means of the unit itself, for temporarily retaining and operatively positioning a strip segment in a predetermined area of said plastic film,
wherein in at least one position of relative angular rotation of said operating units, said punching means are operatively opposed from opposite sides of said plastic film and produce at least one incision in an area of said film, as a result of the mutual approach of said two units by said translation means, and, after the mutual removal of said units by said translation means, in another position of relative angular rotation of said operating units, a strip segment is positioned by said storing means in said area of said plastic film in line with said at least one incision and, in a further position of relative angular rotation of said operating units, said welding means are operatively opposed from opposite sides of the plastic film, as a result of the mutual approach of said units by said translation means , and perform the welding of said strip segment in said area of said plastic film in line with said at least one incision, after which said operating units are mutually spaced apart by said translation means, and wherein said translation means of at least one of said operating units include:
a camshaft stationary with respect to said framework , placed below said lower shaft, having axis parallel and contained in the same vertical plane with respect to that one of said lower shaft and rotated by respective electric motorization means with reducer, fixed in respect of said framework;
supporting means of said lower shaft, including sliding blocks guided in corresponding rectilinear vertical guides fixed with respect to said framework and provided with cam-follower means cooperating with corresponding eccentrics integral with said camshaft.
